(19) United States
(12) Patent Application Publication
(10) Pub. No.: US 2009/0089104 A1
(43) Pub. Date: Apr. 2, 2009

(54) Point-of-Sale Investment Systems

(76) Inventor: Anthony C. Kondaks, Mesa, AZ (US)

Correspondence Address: Anthony C. Kondaks, 1015 S. Longwood Loop, Mesa, AZ, 85208, US

(21) Appl. No.: 12/330,872

(22) Filed: Dec. 9, 2008

Related U.S. Application Data
(63) Continuation of application No. 11/332,044, filed on Jan. 12, 2006.
(60) Provisional application No. 60/644,213, filed on Jan. 13, 2005.

(51) Int. Cl. G06Q 40/00; G06Q 20/00

(52) U.S. Cl. 705/4; 705/37; 705/16

(57) ABSTRACT

As a positive alternative to lottery gambling, this invention permits consumers to elect to make small investments through lottery terminals. The investments are preferably made in a stock market based investment such as an Equity Index Annuity. Consumers may make investments anonymously and then consolidate them later into an account which may be managed in a manner similar to other investments. Subject to the policies regarding early redemption, consumers may also withdraw the invested amounts plus any associated gains.

### CROSS-REFERENCE TO RELATED APPLICATION

The present application is a continuation of nonprovisional patent application Ser. No. 11/332,044, filed Jan. 12, 2006, entitled “POINT-OF-SALE INVESTMENT SYSTEMS”, which claims priority from prior provisional application Ser. No. 60/644,213, filed Jan. 13, 2005, entitled “POINT-OF-SALE INVESTMENT SYSTEM”, the contents of which are incorporated herein by this reference and are not admitted to be prior art with respect to the present invention by the mention in this cross-reference section.

### BACKGROUND

This invention relates to point-of-sale investment systems. More particularly, it relates to providing improved methods and systems for permitting individuals to invest through retail point-of-sale devices, including lottery terminals and gambling devices such as slot machines.

Typically, investing by individuals is a complex and highly regulated process. Individuals make contributions to their investment accounts through brokers or broker representatives in the case of investments in stocks and bonds. Alternatively, individuals often make contributions as part of a variety of insurance-based products, such as universal life policies and equity index annuities. In both cases, the payment amount is quite a bit more than more than pocket change. Finally, the disclosure requirements are significant and overwhelming to many people. The combination of these factors works to exclude many minorities, lower income and other similar demographic groups from participation in sound investments and the “ownership society”.

Furthermore, democratization of the investment markets has long been an objective of many in States as well as the Federal government. Despite record levels of participation, many people can't or won't participate because of the complexities of investing, the large minimum amounts required, the real or perceived risks of loss, and a general lack of understanding.

On the other hand, state-sponsored lotteries enjoy a wide participation by almost all ethnic, demographic and economic segments of the population of the United States. For example, lotteries currently operate in about 44 states and are available to about 87 percent of the U.S. population. Participation by individuals is easy; no special trips or highly trained specialists stand in their way. Also, the amount of money required for participation is so small that, even for the lowest income levels, the decision can be made on impulse, while shopping, with the spare change readily at hand. Unfortunately, although lotteries may result in benefits to society as a whole, they do not return any long-term benefit to the overwhelming majority of participants.

Therefore, it is highly desirable to provide systems for investing small amounts by individuals that are understandable and convenient, are a positive alternative/companion to lottery-based or other gambling, and actively encourage and promote an “ownership society”.

### OBJECTS AND FEATURES OF THE INVENTION

A primary object and feature of the present invention is to provide a system for permitting individuals to easily contribute small amounts to equity-based investments and fixed investments with an equity-based component.

It is a further primary object and feature of the present invention to provide such a system that is available at many of the commercial locations frequented by people.

It is another primary object and feature of the present invention to provide such a system in which the equity-based investment and fixed investments with an equity-based component are understandable by most people.

It is yet another primary object and feature of the present invention to provide such a system that permits irregular contributions to an equity-based investment.

Furthermore, it is a primary object and feature of the present invention to provide such a system that provides establishment of individual ownership of contributions and earnings from the equity-based investments.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a method, relating to offering future ownership in at least one investment, comprising the steps of: offering such future ownership for purchase by at least one investor; wherein such offering is made through at least one retail point-of-sale device; accepting at least one ownership contribution for such future ownership from such at least one investor; assigning at least one unique identifier to such at least one ownership contribution; storing together such at least one ownership contribution and such at least one assigned unique identifier; and confirming such storing together such at least one ownership contribution and such at least one assigned unique identifier to such at least one investor. Moreover, it provides such a method further comprising the steps of: accumulating at least one plurality of such ownership contributions for at least one period of time; creating such at least one investment using such accumulated ownership contributions; associating each such stored ownership contribution and such at least one assigned unique identifier with such at least one investment; and calculating at least one proportional account-holder ownership percentage for each such stored ownership contribution and such at least one assigned unique identifier associated with such at least one investment. Additionally, it provides such a method wherein such at least one proportional account-holder ownership percentage may be owned by at least one anonymous investor. Also, it provides such a method comprising the steps of: permitting such at least one proportional account-holder ownership percentage to become at least one identified account-holder investor; permitting association of such at least one ownership contribution and such at least one assigned unique identifier by such at least one anonymous investor with such at least one identified account-holder investor. In addition, it provides such a method, wherein such at least one proportional account-holder ownership percentage may be owned by at least one identified account-holder investor. And, it provides such a method comprising the steps of: accepting at least one ownership contribution for such future ownership from such at least one identified account-holder investor; associating of such at least one ownership contribution by such at least one identified account-holder investor with such at least one identified account-holder investor; storing together such at least one ownership contribution and such association of such at least one ownership contribution by such at least one identified account-holder investor with such at least one identified account-holder investor; and confirming such storing together such at least one ownership contribution and such association of such at least one ownership contribution by such at least one identified account-holder investor with such at least one identified account-holder investor. Further, it provides such a method further comprising the steps of: determining at least one value of such at least one proportional ownership percentage of such at least one investment for such at least one account-holder investor; and permitting such at least one account-holder investor to withdraw at least one withdrawal amount less than or equal to such at least one determined value of such at least one proportional ownership percentage from such at least one investment. Even further, it provides such a method further comprising the steps of: offering, by at least one licensor, at least one administrative license to at least one investment administrator to administer such at least one investment; and receiving at least one administrative license payment from such at least one investment administrator by such at least one licensor. Moreover, it provides such a method wherein such at least one administrative license payment comprises at least one first percentage of such at least one ownership contribution by such at least one investor. Additionally, it provides such a method wherein such at least one administrative license payment comprises at least one second percentage of the accumulated value, at at least one point in time, of such at least one investment administered by such at least one investment administrator. Also, it provides such a method wherein such at least one administrative license payment comprises at least one third percentage of the accumulated value, at least one point in time, of incremental revenue received from such at least one investor by such at least one investment administrator. In addition, it provides such a method wherein such at least one administrative license payment comprises: at least one first percentage of such at least one ownership contribution by such at least one investor; and at least one second percentage of the accumulated value, at at least one point in time, of such at least one investment administered by such at least one investment administrator. And, it provides such a method further comprising the step of: offering at least one sales license to at least one manufacturer of such at least one retail point-of-sale device by at least one licensor; and receiving at least one sales license payment from such at least one manufacturer by such at least one licensor. Further, it provides such a method wherein such at least one retail point-of-sale device relates to sale of lottery tickets. Even further, it provides such a method wherein such at least one retail point-of-sale device relates to gambling. Moreover, it provides such a method wherein such at least one investment comprises at least one equity index annuity account. Additionally, it provides such a method wherein such at least one equity index annuity account is comprised of at least one fractional ownership by a plurality of investors. Also, it provides such a method wherein such at least one investment comprises at least one individual retirement account. Also, it provides such a method wherein such at least one investment comprises at least one health savings account. In addition, it provides such a method wherein such at least one investment comprises at least one mutual fund account. And, it provides such a method wherein such at least one mutual fund account comprises at least one stock mutual fund account. Further, it provides such a method wherein such at least one mutual fund account comprises at least one bond mutual fund account.

In accordance with another preferred embodiment hereof, this invention provides a method, relating to offering fractional ownership in at least one investment, comprising the steps of: offering such ownership for purchase by at least one investor; wherein such offering is made through at least one lottery point-of-sale device; wherein such at least one investment comprises at least one equity index annuity account; wherein such at least one equity index annuity account is comprised of at least one fractional ownership by a plurality of investors; accepting at least one ownership contribution for such ownership from such at least one investor; assigning at least one unique identifier to such at least one ownership contribution; storing together such at least one ownership contribution and such at least one assigned unique identifier; and confirming such storing together such at least one ownership contribution and such at least one assigned unique identifier to such at least one investor.

### DEFINITIONS, ACRONYMS AND CROSS-REFERENCES

The following terms and acronyms are explained below as background and are used throughout the detailed description:

EIA. An equity-indexed annuity is a fixed annuity, either qualified or non-qualified, that earns interest or provides benefits that are linked to an external equity reference or an equity index. The value of the index might be tied to a stock or other equity index. One of the most commonly used indices is Standard & Poor's 500 Composite Stock Price Index (the S&P 500), which is an equity index. An equity-indexed annuity is a fixed insurance contract which has its return based on a guaranteed minimum interest rate as well as the potential for additional returns based on a specific equity index, but no shares of any stock included in the index are owned by the annuity. Equity index annuities are excellent alternatives for investors seeking safety in a low interest rate environment or a volatile market. The additional return is based on the increase of a stock or equity index, such as the S&P 500. If stocks rise, the EIA value increases. If stocks fall, the EIA value does not decrease, and because the EIA is a fixed insurance contract typically a minimum return, typically 3%, is guaranteed. However, there is no such thing as a free lunch, so the company that issues the annuity will limit the maximum returns received from a rising market in return for the downside protection they provide. This limit depends on the particular indexing method that the annuity company uses. A common method used to limit returns is called the “participation rate.” For example, the insurance company may set the participation at 90%, which means the annuity would be credited with 90% of the growth experienced by the index. If the index gained 10%, the gain for the EIA would be 9% for that year. Essentially, 100% of the market risk is traded for a portion of the market gain.

Health Savings Account (HSA). A health savings account is a tax-sheltered savings account similar to the IRA, but earmarked for medical expenses. Deposits are 100% tax-deductible for the self-employed and almost everyone with an HSA and can be easily withdrawn by check or debit card to pay routine medical bills with tax-free dollars. Larger medical expenses are covered by a required low-cost, high deductible health insurance policy. What is not used from the account each year stays in the account and continues to accumulate interest on a tax-favored basis to supplement retirement, just like an IRA.

Individual Retirement Account (IRA). An IRA may be one of several specific retirement investment accounts allowed by the IRS to provide tax-deferral or other tax advantage. The three types of IRAs available are: deductible IRA which permits tax-deferred contributions; and growth, non-deductible IRA which permits only tax-deferred growth; and Roth IRA which permits tax-free growth. All IRA accounts permit the use of a variety of investment vehicles, for example stock or bond mutual funds, individual stocks, or equity index annuity accounts.

### BRIEF DESCRIPTION OF THE DRAWINGS

FIG. 1 shows a general schematic view illustrating the relationships of the preferred licensing and business relationship of a licensor, lottery terminal manufacturer, retailer, investment administrator, exchange and consumer according to a preferred embodiment of the present invention.

FIG. 2 shows a general schematic view illustrating the relationships of the preferred licensing and business relationship of a licensor, point-of-sale terminal manufacturer, retailer, investment administrator, exchange and consumer according to an alternate preferred embodiment of the present invention.

FIG. 3 shows a general schematic view illustrating steps required to receive a contribution from a consumer according to a preferred embodiment of the present invention.

FIG. 4 shows a general schematic view illustrating steps required to issue an account number to a consumer according to a preferred embodiment of the present invention.

FIG. 5 shows a general schematic view illustrating steps required obtain a statement of the value of a consumer's account number according to a preferred embodiment of the present invention.

FIG. 6 shows a general schematic view illustrating steps required to issue a payment from a consumer's account according to a preferred embodiment of the present invention.

### DETAILED DESCRIPTION OF THE BEST MODES AND PREFERRED EMBODIMENTS OF THE INVENTION

With the intention of enabling the present invention to be more readily understood by those skilled in the art, while at the same time disclosing the advantages that are afforded by the present invention, the following description is subdivided to provide an overview of the primary components and participants giving rise to a preferred embodiment of the present invention. Within each subsection of this description, reference is made by title to other system components and participants when and as necessary to assist in understanding system inter-relationships. Following the description of each sub-component and an identification of the pathways of communication between components, a description of the interaction of the components and participants in functional application as taught by the present invention is provided.

In the accompanying drawings, well-known structures and devices are shown in block diagram form in order to provide an understanding of the interrelationships between components and participants and the flow of information and control throughout described preferred embodiments of the present invention. It will be apparent to one skilled in the art that the invention may, under appropriate circumstances, be practiced with a variety of different specific components provided to serve the generalized block diagram description.

A fundamental principle as taught by the present invention rests upon the premise that alternative methods of investing are required to encourage investing by a greater percentage of the general public. Additionally, people wishing to invest small amounts must be encouraged and be permitted to make small investments in a variety of familiar settings through a variety of convenient methods.

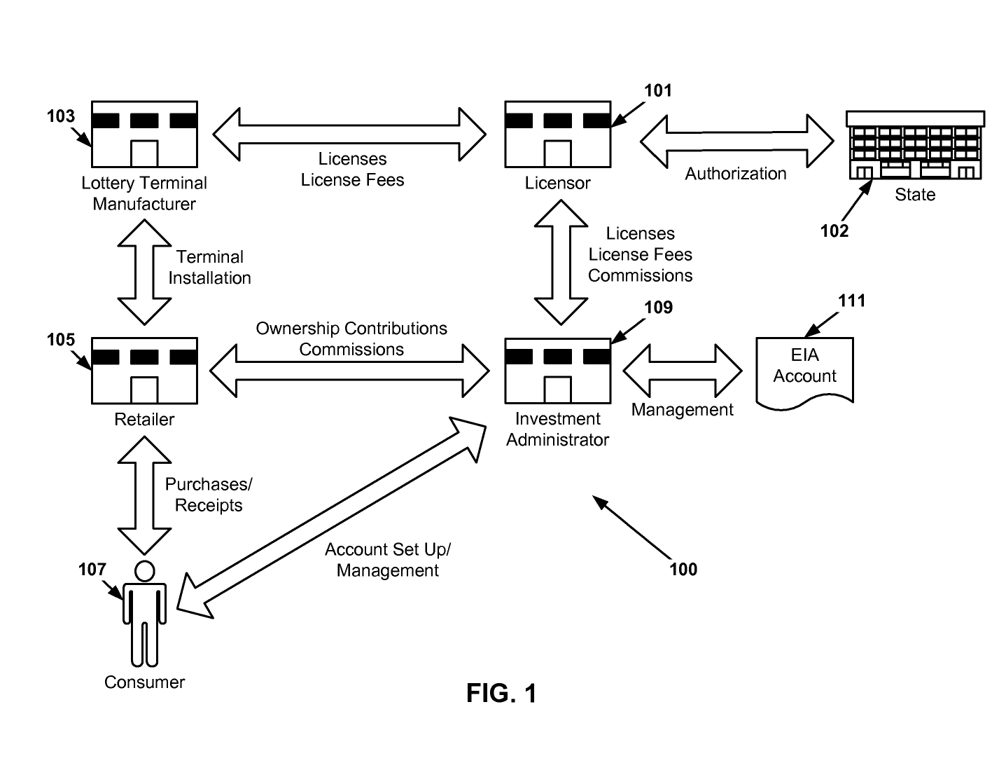

Referring to FIG. 1, a general schematic view is presented illustrating the relationships, according to a preferred embodiment of the present invention, of the preferred licensing and business relationship of a licensor, at least one lottery terminal manufacturer, at least one retailer, at least one investment administrator, and at least one consumer. According to a preferred embodiment of the present invention, the Lottery Point-of-Sale Investment System 100 preferably permits a Consumer 107 to contribute to an EIA (Equity Index Annuity) Account 111 through a lottery terminal located at a Retailer 105 (at least embodying herein wherein such at least one retail point-of-sale device relates to sale of lottery tickets).

According to a preferred embodiment of the present invention, Licensor 101 will obtain authorization from the State 102, which already permits a lottery to be offered to Consumers 107, to market and sell fractional-ownership EIA investments (at least embodying herein wherein such at least one investment comprises at least one equity index annuity account; and at least embodying herein wherein such at least one equity index annuity account is comprised of at least one fractional ownership by a plurality of investors). Authorization may be required from one or more state agencies or institutions. For example, it may be necessary for the state legislature to approve the offering of investment programs through lottery terminals. Additionally, sales of a fractional-ownership based investment such as an EIA (Equity Index Annuity) may require legislative and or insurance departmental approval. Preferably, the investment aspects of a fractional-ownership EIA product operate in the same manner as single-ownership based EIA product sold by insurance companies as described above. Preferably, ownership contributions by a group of Consumers 107 are accumulated until a specific amount is achieved, say $50,000, at which time the amount is used to set up an EIA Account 111 with the typical rules for calculating the gain in value and participation level (at least embodying herein accumulating at least one plurality of such at least one ownership contributions for at least one period of time; and at least embodying herein creating such at least one investment using such accumulated ownership contributions).

Additionally, each ownership contribution included in the EIA Account 111 will preferably be accounted for individually for the life of the EIA Account 111 (at least embodying herein associating each such stored ownership contribution and such at least one assigned unique identifier with such at least one investment). At the termination of the EIA Account 111, the value of each ownership contribution will preferably be calculated by multiplying its percentage ownership in the EIA Account 111 when the EIA Account 111 was established times the ending value of the EIA Account 111 (at least embodying herein calculating at least one proportional account-holder ownership percentage for each such stored at least one ownership contribution and such at least one assigned unique identifier associated with such at least one investment). Upon reading the teachings of this specification, those with ordinary skill in the art will now understand that, under appropriate circumstances, considering such issues as market changes, the nature of the EIA rules in various states, insurance company requirements, etc., various methods of valuation of an EIA account may suffice. Preferably, at the termination of EIA Account 111, each owner of the EIA Account 111 may be permitted to receive the value of the ownership percentage or make a new ownership contribution in another EIA Account 111. Upon reading the teachings of this specification, those with ordinary skill in the art will now understand that, under appropriate circumstances, considering such issues as market changes, the nature of the EIA rules in various states, insurance company requirements, etc., various methods, and combinations of methods of payment and investment, such as via telephone, via the Internet or in person at the office or branch of the Investment Administrator, may suffice.

Preferably, the Licensor 101 will identify and negotiate an administrative agreement with at least one Investment Administrator 109 to accept and manage ownership contributions received from lottery terminals located at any Retailer 105 (at least embodying herein offering, by at least one licensor, at least one administrative license to at least one investment administrator to administer such at least one investment). Preferably, the Investment Administrator 109 will be at least one insurance company that is authorized to offer an EIA product. Preferably, the administrative agreement includes, but is not limited to, establishment of an insurance-based EIA (Equity Index Annuity) product which permits fractional ownership by Consumers 107, accounting for ownership contributions which are anonymous or for pre-existing consumer accounts, providing necessary management and reporting to Consumer 107 for an account set up on request by Consumer 107, and consolidation of anonymous ownership contributions to a consumer account on request by Consumer 107. Upon reading the teachings of this specification, those with ordinary skill in the art will now understand that, under appropriate circumstances, considering such issues as state regulatory requirements, market changes, the nature of the EIA rules in various states, insurance company requirements, etc., companies other than insurance companies operating as the Investment Administrator, and in turn acquiring EIA contracts from one or more insurance companies that offer an EIA product, may suffice.

Preferably, fractional-ownership EIA's will be structured to permit ownership contributions by Consumers 107 to a fractional-ownership EIA to be eligible for use at part of an IRA or HSA in the same manner as any eligible non-fractional-ownership (at least embodying herein wherein such at least one investment comprises at least one individual retirement account; and at least embodying herein wherein such at least one investment comprises at least one health savings account).

Preferably, the Licensor 101 will negotiate a licensing agreement with at least one Lottery Terminal Manufacturer 103 to permit the Lottery Terminal Manufacturer 103 to modify the lottery terminal software used to operate its lottery terminals to accept and process ownership contributions (at least embodying herein offering at least one sales license to at least one manufacturer of such at least one retail point-of-sale device by at least one licensor). The lottery terminal software modifications permitted will preferably include:
Permitting a Consumer 107 to elect to make an ownership contribution through the lottery terminal. The ownership contribution transaction preferably may be made either in conjunction with the purchase of a lottery ticket or, more preferably, solely as an ownership contribution;
Permitting a Consumer 107 to make the ownership contribution anonymously;
Permitting a Consumer 107 to make the ownership contribution to a pre-existing consumer account using an account number provided by the Consumer 107;
Providing to the Consumer 107 a proof-of-purchase for anonymous ownership contributions which includes a unique transaction identifier;
Providing to the Consumer 107 a receipt for ownership contributions associated with a pre-existing consumer account;
Providing the necessary controls, reports and methods to permit periodic transmission of ownership contributions to the Investment Administrator 109.

Upon reading the teachings of this specification, those with ordinary skill in the art will now understand that, under appropriate circumstances, considering such issues as developer preferences, requirements for other methods and software functions, the nature of the application and changes in technology, etc., other methods and software functions may suffice.

Upon reading the teachings of this specification, those with ordinary skill in the art will now understand that, under appropriate circumstances, considering such issues as Retailer preferences, the nature of the application and changes in technology, etc., any type of lottery terminal, such as manned lottery terminals, video lottery terminals or Internet-based lottery terminals, may suffice.

According to a preferred embodiment of the present invention, Licensor 101 will preferably receive a licensee fee from the Lottery Terminal Manufacturer 103. Preferably, the license fee will be negotiated on the basis of the number of lottery terminals on which the revised software is installed (at least embodying herein receiving at least one sales license payment from such at least one manufacturer by such at least one licensor). Upon reading the teachings of this specification, those with ordinary skill in the art will now understand that, under appropriate circumstances, considering such issues as Lottery Terminal Manufacturer preferences, Licensor preferences, the nature of the application and changes in technology, etc., other methods of license fee calculation, such an agreed payment per ownership contribution processed, may suffice.

According to a preferred embodiment of the present invention, the Lottery Terminal Manufacturer 103 will preferably install the updated lottery terminal software at each Retailer 105 which has a lottery terminal located on their premises. Preferably, once the updated software is installed, a Consumer 107 may elect to solely make an ownership contribution or make an ownership contribution in conjunction with the purchase of a lottery ticket.

According to a preferred embodiment of the present invention, the Investment Administrator 109 will be an insurance company that is a provider of EIA products. Generally, insurance companies that already offer EIA products will be in the best position to manage the EIA Account 111. Upon reading the teachings of this specification, those with ordinary skill in the art will now understand that, under appropriate circumstances, considering such issues as Licensor preferences, the nature of the EIA Account and changes in technology, etc., companies other than insurance companies acting as Investment Administrator may suffice.

Preferably, periodically the accumulated ownership contributions and related documentation will be forwarded to the Investment Administrator 109. Preferably, the Investment Administrator 109 will pay Retailer 105 a commission calculated on the basis of the accumulated ownership contributions submitted for a specific period of time. Upon reading the teachings of this specification, those with ordinary skill in the art will now understand that, under appropriate circumstances, considering such issues as Licensor preferences, Retailer preferences, Investment Administrator preferences, the nature of the application and changes in technology, etc., other commission calculation methods may suffice.

Preferably, the Investment Administrator 109 will manage all the administrative aspects of each EIA Account 111 including establishing consumer accounts of Consumers 107 who wish to establish consumer accounts in which their ownership contributions may be summarized and reported, providing assistance to Consumers 107 regarding their ownership contributions, managing and investing funds as necessary to support each EIA Account 111, calculation of amounts to be paid and payments to Consumers 107 when requested and any other actions necessary to successfully operate and manage each EIA Account 111.

Preferably, as part of the licensing agreement between the Investment Administrator 109 and the Licensor 101, the Investment Administrator 109 will pay the Licensor 101 a first commission based on an agreed percentage of the cumulative sum of ownership contributions for each particular period of time (at least embodying herein receiving at least one administrative license payment from such at least one investment administrator by such at least one licensor; and at least embodying herein wherein such at least one administrative license payment comprises at least one first percentage of such at least one ownership contribution by such at least one investor). Additionally, preferably the Investment Administrator 109 will pay the Licensor 101 a second commission based on an agreed percentage of incremental revenue received by the Investment Administrator 109 from Consumers 107 with consumer accounts for ownership contributions (at least embodying herein wherein such at least one administrative license payment comprises at least one third percentage of the accumulated value, at least one point in time, of incremental revenue received from such at least one investor by such at least one investment administrator). Additionally, preferably the Investment Administrator 109 will pay the Licensor 101 a third commission based on total of all ownership contributions invested in EIA's at a particular point in time, such as each year on an agreed date (at least embodying herein wherein such at least one administrative license payment comprises at least one second percentage of the accumulated value, at at least one point in time, of such at least one investment administered by such at least one investment administrator). Upon reading the teachings of this specification, those with ordinary skill in the art will now understand that, under appropriate circumstances, considering such issues as Licensor preferences, Investment Administrator preferences, etc., other commission arrangements such as a combination of only the first commission and second commissions, or other combination of commission calculations, etc., may suffice.

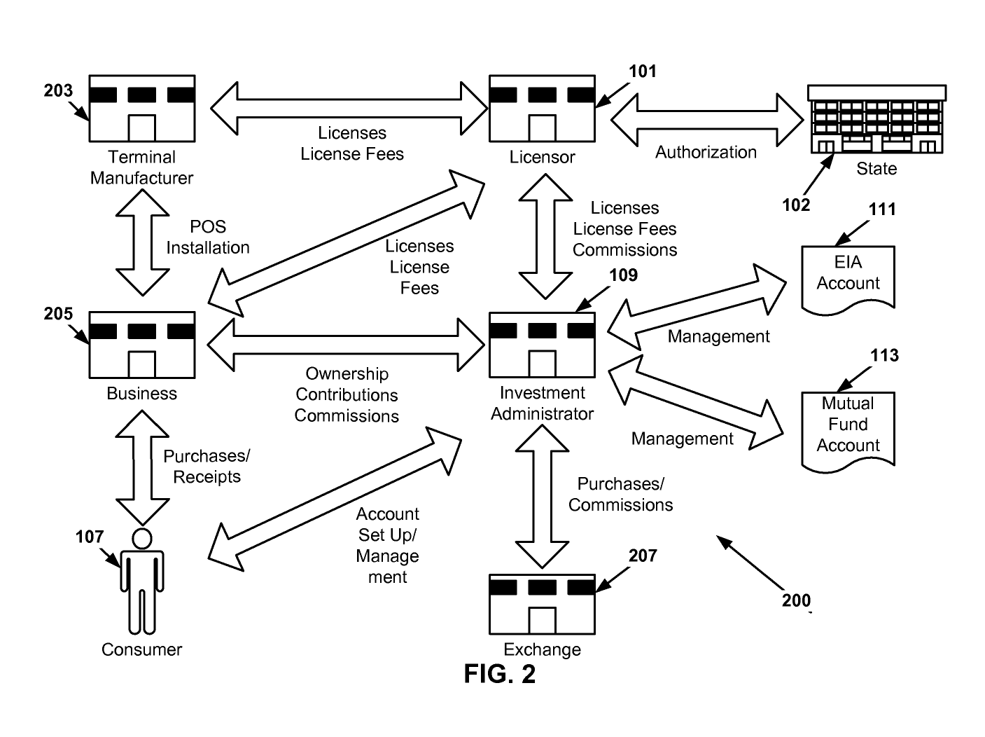

Referring to FIG. 2, a general schematic view illustrating the relationships of the preferred licensing and business relationship of a licensor, point-of-sale terminal manufacturer, a business, investment administrator, exchange and consumer, according to an alternate preferred embodiment of the present invention, is presented. According to an alternate preferred embodiment of the present invention, the Retail Point-of-Sale Investment System 200 preferably permits a Consumer 107 to contribute to an EIA Account 111 through any one of a variety of POS (Point-of-Sale) terminals located at any one of a variety of Businesses 205.

According to an alternate preferred embodiment of the present invention, Licensor 101 will obtain authorization from the State 102 to market and sell fractional-ownership EIA accounts to Consumer 107 through retail POS terminals. Authorization may be required from one or more state agencies or institutions (or from Federal agencies if investment is regulated by the Securities and Exchange Commission). For example, it may be necessary for the state legislature to approve the offering of and investment programs through POS terminals. Additionally, sales of a fractional-ownership based investment such as an EIA (Equity Index Annuity) may require legislative and or insurance departmental approval. Preferably, the investment aspects of a fractional-ownership EIA product operate in the same manner as single-ownership based EIA product sold by insurance companies, as described above. Preferably, ownership contributions by a group of Consumers 107 is accumulated until a specific amount is achieved, say $50,000, at which time the amount is used to set up an EIA Account 111 with the typical rules for calculating the gain in value and participation level. Additionally, each ownership contribution included in the EIA Account 111 will preferably be accounted for individually for the life of the EIA Account 111. At the termination of the EIA Account 111, the value of each ownership contribution will preferably be calculated by multiplying its percentage ownership in the EIA Account 111 when the EIA Account 111 was established times the ending value of the EIA Account 111. Upon reading the teachings of this specification, those with ordinary skill in the art will now understand that, under appropriate circumstances, considering such issues as market changes, the nature of the EIA rules in various states, insurance company requirements, etc., various methods of valuation of an EIA account may suffice. Preferably, at the termination of EIA Account 111, each fractional owner of the EIA Account 111 may be permitted to receive the value of the ownership percentage or make a new ownership contribution in another EIA Account 111. Upon reading the teachings of this specification, those with ordinary skill in the art will now understand that, under appropriate circumstances, considering such issues as market changes, the nature of the EIA rules in various states, insurance company requirements, etc., various methods, and combinations of methods, of payment and investment such as, via telephone, via the Internet or in person at the offices of the Investment Administrator, may suffice.

According to an alternate preferred embodiment of the present invention, assuming necessary regulatory approvals, Licensor 101 may preferably market and sell fractional-ownership of other investment vehicles, such as Mutual Fund Account 113, to Consumer 107 through retail POS terminals. Preferably, these other investment vehicles include common stock mutual funds, bond mutual funds, and money market funds (at least herein embodying wherein such at least one investment comprises at least one mutual fund account; at least herein embodying wherein such at least one mutual fund account comprises at least one stock mutual fund account; and wherein such at least one mutual fund account comprises at least one bond mutual fund account).

Upon reading the teachings of this specification, those with ordinary skill in the art will now understand that, under appropriate circumstances, considering such issues as developer preferences, the nature of the application and changes in technology, etc., other types of investment accounts, such as unit investment trusts, index funds, Real estate investment trusts, and other investment methods, may suffice.

According to an alternate preferred embodiment of the present invention, preferably the Licensor 101 will identify and negotiate an administrative agreement with at least one Investment Administrator 109, which may be an insurance company authorized to offer EIA-based products within the state, to accept and manage ownership contributions received from POS terminals located at any Business 205. Preferably, the administrative agreement includes, but is not limited to, establishment of an insurance-based EIA (Equity Index Annuity) product which permits fractional ownership by Consumers 107 or other investment vehicle, accounting for ownership contributions which are anonymous or for pre-existing consumer accounts, providing necessary management and reporting to Consumer 107, account set up on request by Consumer 107, and consolidation of anonymous ownership contributions to a consumer account on request by Consumer 107. Upon reading the teachings of this specification, those with ordinary skill in the art will now understand that, under appropriate circumstances, considering such issues as state regulatory requirements, market changes, the nature of the EIA rules in various states, insurance company requirements, etc., companies other than insurance companies acting as the Investment Administrator and in turn acquiring EIA contracts from one more insurance companies that offer an EIA product may suffice.

According to an alternate preferred embodiment of the present invention, preferably, the Licensor 101 will negotiate a licensing agreement with at least one POS Terminal Manufacturer 203 to permit the Terminal Manufacturer 203 to modify the POS terminal software used to operate POS terminal. The POS terminal software modifications permitted will preferably include:
Permitting a Consumer 107 to elect to make an ownership contribution through the POS terminal. The ownership contribution transaction preferably may be made either in conjunction with a purchase or solely as an ownership contribution;
Permitting a Consumer 107 to make the ownership contribution anonymously;
Permitting a Consumer 107 to make the ownership contribution to a pre-existing consumer account using an account number provided by the Consumer 107;
Providing to the Consumer 107 a proof-of-purchase for anonymous ownership contributions which includes a unique transaction identifier;
Providing to the Consumer 107 a receipt for ownership contributions associated with a pre-existing EIA Account 111;
Providing the necessary controls, reports and methods to permit periodic transmission of ownership contributions to the Investment Administrator 109.

Upon reading the teachings of this specification, those with ordinary skill in the art will now understand that, under appropriate circumstances, considering such issues as developer preferences, requirements for other methods and software functions, the nature of the application and changes in technology, etc., other methods and software functions may suffice.

According to an alternate preferred embodiment of the present invention, preferably any device capable of receiving and recording payments by Consumer 107 is considered a candidate for modification. Preferably, gambling devices, including slot machines, video poker machines and similar devices, may be modified to permit Consumer 107 to designate an amount as an ownership contribution (at least herein embodying wherein such at least one retail point-of-sale device relates to gambling). Preferably, the amount designated by Consumer 107 may be in addition to amounts being bet or as an amount to be taken from winnings.

According to a preferred embodiment of the present invention, other point-of-sale devices which may be modified to accept ownership contributions may also include:
Retail POS machines
ATMs (Automated Teller Machines) for banking activities,
Retail electronic cash registers,
Automated POS terminals including gasoline pumps which permit use of credit cards and unattended/automated POS terminals in use at grocery stores, and
E-commerce software used to support Internet-based purchases (at least embodying herein wherein such offering is made through at least one retail point-of-sale device).

Upon reading the teachings of this specification, those with ordinary skill in the art will now understand that, under appropriate circumstances, considering such issues as retailer preferences, the nature of the application and changes in technology, etc., any type of mechanism supported by modifiable software such as electromechanical devices or software only systems, may suffice.

According to an alternate preferred embodiment of the present invention, Licensor 101 will preferably receive a licensee fee from Terminal Manufacturer 203. Preferably, the license fee will be negotiated on the basis of the number of POS terminals on which the modified software is installed. Upon reading the teachings of this specification, those with ordinary skill in the art will now understand that, under appropriate circumstances, considering such issues as Terminal Manufacturer preferences, Licensor preferences, the nature of the application and changes in technology, etc., other methods of license fee calculation, such as an agreed payment per ownership contribution processed, may suffice.

According to an alternate preferred embodiment of the present invention, preferably the Licensor 101 will identify and negotiate an agreement with at least one Business 205 to permit Consumer 107 to make an ownership contribution through the POS terminals operated by Business 205.

According to an alternate preferred embodiment of the present invention, Terminal Manufacturer 203 will preferably install the modified POS terminal software at each Business 205 which has agreed to offer ownership contributions through their POS terminals. Preferably, once the updated software is installed, Consumer 107 may elect to solely make an ownership contribution or make an ownership contribution in conjunction with a purchase. According to an alternate preferred embodiment of the present invention, the Investment Administrator 109 will be an insurance company that is a provider of EIA products. Generally, insurance companies that already offer EIA products will be in the best position to manage the EIA Account 111. Upon reading the teachings of this specification, those with ordinary skill in the art will now understand that, under appropriate circumstances, considering such issues as Licensor preferences, the nature of the EIA account and changes in technology, etc., companies other than insurance companies acting as Investment Administrator may suffice.

According to an alternate preferred embodiment of the present invention, preferably, periodically the accumulated ownership contributions and related documentation will be forwarded to the Investment Administrator 109. Preferably, the Investment Administrator 109 will pay Business 205 a commission calculated on the basis of the accumulated ownership contributions submitted for a specific period of time. Upon reading the teachings of this specification, those with ordinary skill in the art will now understand that, under appropriate circumstances, considering such issues as Licensor preferences, Retailer preferences, Investment Administrator preferences, the nature of the application and changes in technology, etc., other commission calculation methods may suffice.

According to an alternate preferred embodiment of the present invention, preferably, the Investment Administrator 109 will manage all the administrative aspects of each EIA Account 111 including, but not limited to, establishing consumer accounts of Consumers 107 who wish to establish consumer accounts in which their ownership contributions may be summarized and reported, providing assistance to Consumers 107 regarding their ownership contributions, managing and investing funds as necessary to support each EIA Account 111, calculation of amounts to be paid, and payments to Consumers 107 when requested, and any other actions necessary to successfully operate and manage each EIA Account 111.

According to an alternate preferred embodiment of the present invention, preferably, as part of the licensing agreement between the Investment Administrator 109 and the Licensor 101, the Investment Administrator 109 will pay the Licensor 101 a first commission based on an agreed percentage of the cumulative sum of ownership contributions for each particular period of time. Additionally, preferably the Investment Administrator 109 will pay the Licensor 101 a second commission based on an agreed percentage of incremental revenue received by the Investment Administrator 109 from Consumers 107 with consumer accounts for ownership contributions. Additionally, preferably the Investment Administrator 109 will pay the Licensor 101 a third commission based on total of all ownership contributions invested in EIA's at a particular point in time, such as each year on an agreed date. Upon reading the teachings of this specification, those with ordinary skill in the art will now understand that, under appropriate circumstances, considering such issues as Licensor preferences, Investment Administrator, etc., other commission arrangements such as a combination of only the first commission and second commissions, or other combination of commission calculations, etc., may suffice.

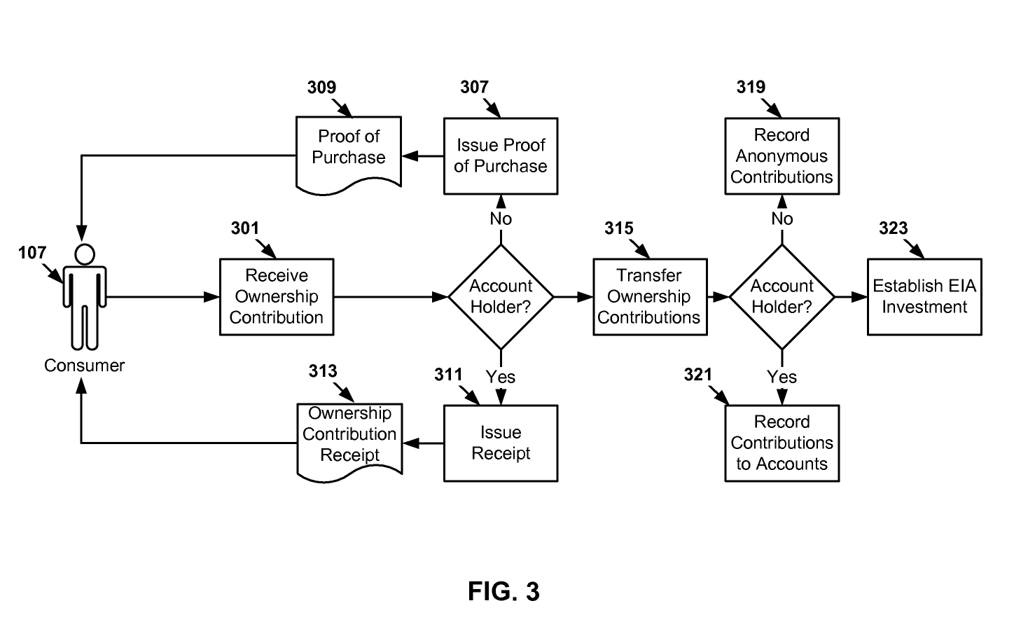

Referring to FIG. 3, a general schematic view illustrating steps required to receive a contribution from a consumer, according to a preferred embodiment of the present invention, is presented. Consumer 107 initiates the process by choosing to make an ownership contribution. Preferably, in the step Receive Ownership Contribution 301, a Consumer 107 chooses to make a voluntary ownership contribution (at least embodying herein offering such future ownership for purchase by at least one investor; and at least embodying herein accepting at least one ownership contribution for such future ownership from such at least one investor). Preferably, the ownership contribution may or may not be in made in conjunction with the purchase of a lottery ticket. Preferably, the ownership contribution may be made through any type of lottery terminal which accepts the contribution. Preferably, the ownership contribution may be anonymous or for addition to an existing consumer account of the Consumer 107 (at least embodying herein wherein such at least one proportional account-holder ownership percentage may be owned by at least one anonymous investor). Preferably, if the ownership contribution is for an existing consumer account, the Consumer 107 will provide the necessary account information to permit the ownership contribution to be credited to the appropriate consumer account. A preferred alternative is that the account information will be stored on an account card which is readable by the lottery terminal in a manner similar to a credit card.

Preferably, a determination will be made as to whether the ownership contribution is anonymous or for a specified account holder. If the ownership contribution is anonymous, the step Issue Proof of Purchase 307 is taken to assign a unique identification code to the ownership contribution and to issue a Proof of Purchase 309 which contains all the pertinent information regarding the ownership contribution, including the unique identification code (at least embodying herein assigning at least one unique identifier to such at least one ownership contribution; and at least embodying herein confirming such storing together such at least one ownership contribution and such at least one assigned unique identifier to such at least one investor). Preferably, a unique identification code is assigned to each anonymous ownership contribution to permit management of the ownership contribution until the ownership contribution is associated with an account holder or until the EIA reaches maturity (at least embodying herein storing together such at least one ownership contribution and such at least one assigned unique identifier).

Preferably, if the ownership contribution is for a specified account holder the step Issue Receipt 311 is completed and an Ownership Contribution Receipt 313 is issued (at least embodying herein accepting at least one ownership contribution for such future ownership from such at least one identified account-holder investor; and at least embodying herein associating of such at least one ownership contribution by such at least one identified account-holder investor with such at least one identified account-holder investor; and at least embodying herein storing together such at least one ownership contribution and such association of such at least one ownership contribution by such at least one identified account-holder investor with such at least one identified account-holder investor; and at least embodying herein confirming such storing together such at least one ownership contribution and such association of such at least one ownership contribution by such at least one identified account-holder investor with such at least one identified account-holder investor). Preferably, the Ownership Contribution Receipt 313 contains all the pertinent information regarding the ownership contribution, including the account holder's account number.

Preferably, periodically the accumulated ownership contributions and the related documentation are transferred to the Investment Administrator 109 for investment and account administration as shown in step Transfer Ownership Contributions 315 (at least herein embodying accumulating at least one plurality of such ownership contributions for at least one period of time). Preferably, the Investment Administrator 109 will record the amount and contribution date, etc., separately each for anonymous ownership contribution according to the assigned unique identification number in step Record Anonymous Contributions 319. Preferably, the Investment Administrator 109 will record the amount and contribution date, etc., separately each for account holder ownership contribution according to the associated account number in step Record Contributions Accounts 321. Preferably, periodically the Investment Administrator 109 will establish a new EIA investment in step Establish EIA Investment 323. Preferably, establishment of a new EIA investment will be based at least on the accumulated ownership contributions regardless of their source. Preferably, each ownership contribution, regardless of the source, included in any particular EIA investment is managed in the same manner for calculation of the ownership share and increases in value. However, multiple ownership contributions associated with a single account holder included in a particular EIA investment preferably would be consolidated.

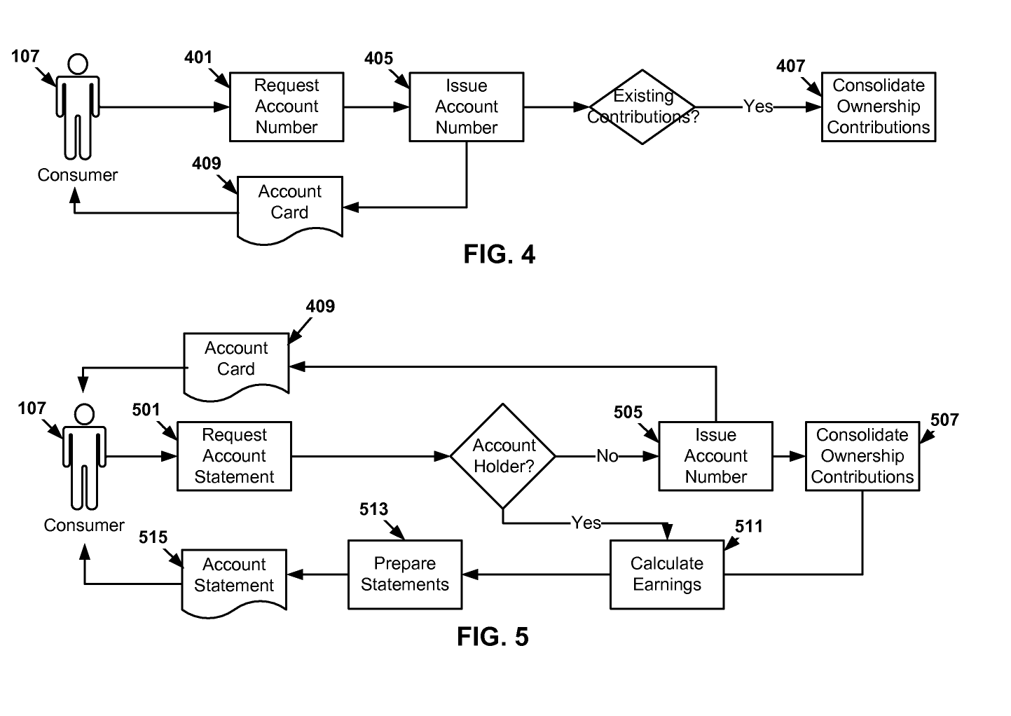

Referring to FIG. 4, in which a general schematic view illustrating steps required to issue an account number to a consumer, according to a preferred embodiment of the present invention, is presented, the Consumer 107 may at any time request that an account be set up by the Investment Administrator 109 as shown in the step Request Account Number 401 (at least embodying herein permitting such at least one proportional account-holder ownership percentage to become at least one identified account-holder investor). Preferably, the Investment Administrator 109 will complete the necessary actions to assign a unique account number to the requesting Consumer 107 and establish a consumer account on behalf of the Consumer 107. Preferably, the Investment Administrator 109 will be notified whether the Consumer 107 has previously made anonymous ownership contributions as part of the step Request Account Number 401. Preferably, as shown in step Consolidate Ownership Contributions 407, the Investment Administrator 109 will consolidate all anonymous ownership contributions, for which the Consumer 107 has a Proof of Purchase 309, into the newly established consumer account as shown in the step Consolidate Ownership Contributions 407 (at least embodying herein permitting association of such at least one ownership contribution and such at least one assigned unique identifier by such at least one anonymous investor with such at least one identified account-holder investor). Preferably, the Investment Administrator 109 will issue an Account Card 409 which contains the necessary information, such as account number for use by the Consumer 107 as part of the step Issue Account Number 405. Preferably, the Consumer 107 may request an account number in advance of making ownership contributions.

Referring to FIG. 5, in which a general schematic view illustrating steps required obtain a statement of the value of a consumer's account number, according to a preferred embodiment of the present invention, is presented, any Consumer 107 may request a statement which summarizes all ownership contributions by the Consumer 107. Preferably, as shown in the step Request Account Statement 501, any Consumer 107 who has made ownership contributions may request a statement summarizing their ownership contributions and the current value of each ownership contribution and the pertinent information regarding the EIA account with which each ownership contribution is associated. Preferably, if the Consumer 107 is not a current account holder, they will present Proofs of Purchase 309 and an Account Card 409 with a unique account number will be issued, as shown in the step Issue Account Number 505. Following the step Issue Account Number 505, all the ownership contributions by the Consumer 107 will be associated with the account number for the Consumer 107. For newly issued accounts and existing accounts, the value of each ownership contribution will then be calculated in the step Calculate Earnings 511. Following the step Calculate Earnings 511, the Account Statement 515, which presents a summary of each ownership contribution, is associated EIA account and its current value will be provided to the Consumer 107. Preferably, the Account Statement 515 may periodically be automatically sent to each Consumer 107 with an account number. Upon reading the teachings of this specification, those with ordinary skill in the art will now understand that, under appropriate circumstances, considering such issues as advances in technology, user preference, user location, etc., other methods and forms of presenting the Account Statement, such as via an Internet-based query, via a telephone-based request or from a lottery terminal, etc., may suffice.

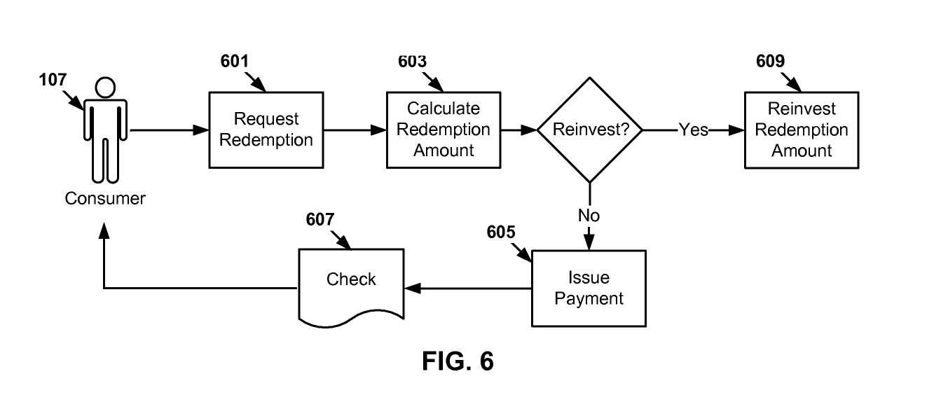

Referring to FIG. 6, in which a general schematic view illustrating steps required to issue a payment from a consumer's account, according to a preferred embodiment of the present invention, is presented, the Consumer 107 may request redemption of all or a portion of an account containing ownership contributions. Preferably, only Consumers 107 with an account number will be permitted to make a redemption request as shown in the step Request Redemption 601. Preferably, the Consumer 107 may request redemption at the termination of the EIA account with which one or more ownership contributions is associated (at least embodying herein permitting such at least one account-holder investor to withdraw at least one withdrawal amount less than or equal to such at least one determined value of such at least one proportional ownership percentage from such at least one investment). Preferably, redemptions would be subject to rules relating to normal redemptions, early redemption, and re-investment of redemption proceeds. Upon reading the teachings of this specification, those with ordinary skill in the art will now understand that, under appropriate circumstances, considering such issues as advances in technology, user preference, user location, etc., other methods and forms of requesting redemption of some or all the ownership contributions associated with an account, such as via an Internet-based query, via a telephone-based request or from a lottery terminal, etc., may suffice. After a redemption request is received, the value of the ownership contributions is calculated according the established rules in the step Calculate Redemption Amount 603 (at least embodying herein determining at least one value of such at least one proportional ownership percentage of such at least one investment for such at least one account-holder investor). If the Consumer 107 has elected to reinvest the redemption proceeds, the funds will be placed in another EIA account along with other ownership contributions, as shown in the step Reinvest Redemption Amount 609. On the other hand, if the Consumer 107 has chosen to receive payment, a Check 607 will be issued in the step Issue Payment 605.

Upon reading the teachings of this specification, those with ordinary skill in the art will now understand that, under appropriate circumstances, considering such issues as advances in technology, user preferences, Investment Administrator preferences, etc., permitting anonymous contributions to be redeemed upon presentation of a proof of purchase by a consumer may suffice.

Although applicant has described applicant's preferred embodiments of this invention, it will be understood that the broadest scope of this invention includes modifications such as diverse shapes, sizes, and materials. Such scope is limited only by the below claims as read in connection with the above specification.

Further, many other advantages of applicant's invention will be apparent to those skilled in the art from the above descriptions and the below claims.

What is claimed is:

1) A method, relating to offering future ownership in at least one investment, comprising the steps of:
a) offering such future ownership for purchase by at least one investor;
b) wherein such offering is made through at least one retail point-of-sale device;
c) accepting at least one ownership contribution for such future ownership from such at least one investor;
d) assigning at least one unique identifier to such at least one ownership contribution;
e) storing together such at least one ownership contribution and such at least one assigned unique identifier; and
f) confirming such storing together such at least one ownership contribution and such at least one assigned unique identifier to such at least one investor.

2) The method, according to claim 1, further comprising the steps of:
a) accumulating at least one plurality of such ownership contributions for at least one period of time;
b) creating such at least one investment using such accumulated ownership contributions;
c) associating each such stored ownership contribution and such at least one assigned unique identifier with such at least one investment; and
d) calculating at least one proportional account-holder ownership percentage for each such stored ownership contribution and such at least one assigned unique identifier associated with such at least one investment.

3) The method, according to claim 2, wherein such at least one proportional account-holder ownership percentage may be owned by at least one anonymous investor.

4) The method, according to claim 3, comprising the steps of:
a) permitting such at least one proportional account-holder ownership percentage to become at least one identified account-holder investor; and
b) permitting association of such at least one ownership contribution and such at least one assigned unique identifier by such at least one anonymous investor with such at least one identified account-holder investor.

5) The method, according to claim 2, wherein such at least one proportional account-holder ownership percentage may be owned by at least one identified account-holder investor.

6) The method, according to claim 5, comprising the steps of:
a) accepting at least one ownership contribution for such future ownership from such at least one identified account-holder investor;
b) associating of such at least one ownership contribution by such at least one identified account-holder investor with such at least one identified account- holder investor;
c) storing together such at least one ownership contribution and such association of such at least one ownership contribution by such at least one identified account-holder investor with such at least one identified account-holder investor; and
d) confirming such storing together such at least one ownership contribution and such association of such at least one ownership contribution by such at least one identified account-holder investor with such at least one identified account-holder investor.

7) The method, according to claim 6, further comprising the steps of:
a) determining at least one value of such at least one proportional ownership percentage of such at least one investment for such at least one account-holder investor; and
b) permitting such at least one account-holder investor to withdraw at least one withdrawal amount less than or equal to such at least one determined value of such at least one proportional ownership percentage from such at least one investment.

8) The method, according to claim 2, further comprising the steps of:
a) offering, by at least one licensor, at least one administrative license to at least one investment administrator to administer such at least one investment; and
b) receiving at least one administrative license payment from such at least one investment administrator by such at least one licensor.

9) The method, according to claim 8, wherein such at least one administrative license payment comprises at least one first percentage of such at least one ownership contribution by such at least one investor.

10) The method, according to claim 8, wherein such at least one administrative license payment comprises at least one second percentage of the accumulated value, at at least one point in time, of such at least one investment administered by such at least one investment administrator.

11) The method, according to claim 8, wherein such at least one administrative license payment comprises at least one third percentage of the accumulated value, at at least one point in time, of incremental revenue received from such at least one investor by such at least one investment administrator.

12) The method, according to claim 8, wherein such at least one administrative license payment comprises:
a) at least one first percentage of such at least one ownership contribution by such at least one investor; and
b) at least one second percentage of the accumulated value, at at least one point in time, of such at least one investment administered by such at least one investment administrator.

13) The method, according to claim 2, further comprising the step of:
a) offering at least one sales license to at least one manufacturer of such at least one retail point-of-sale device by at least one licensor; and
b) receiving at least one sales license payment from such at least one manufacturer by such at least one licensor.

14) The method, according to claim 2, wherein such at least one retail point-of-sale device relates to sale of lottery tickets.

15) The method, according to claim 2, wherein such at least one retail point-of-sale device relates to gambling.

16) The method, according to claim 2, wherein such at least one investment comprises at least one equity index annuity account.

17) The method, according to claim 16, wherein such at least one equity index annuity account is comprised of at least one fractional ownership by a plurality of investors.

18) The method, according to claim 2, wherein such at least one investment comprises at least one individual retirement account.

19) The method, according to claim 2, wherein such at least one investment comprises at least one health savings account.

20) The method, according to claim 2, wherein such at least one investment comprises at least one mutual fund account.

21) The method, according to claim 20, wherein such at least one mutual fund account comprises at least one stock mutual fund account.

22) The method, according to claim 20, wherein such at least one mutual fund account comprises at least one bond mutual fund account.

23) A method, relating to offering fractional ownership in at least one investment, comprising the steps of:
a) offering such ownership for purchase by at least one investor;
b) wherein such offering is made through at least one lottery point-of-sale device;
c) wherein such at least one investment comprises at least one equity index annuity account;
d) wherein such at least one equity index annuity account is comprised of at least one fractional ownership by a plurality of investors;
e) accepting at least one ownership contribution for such ownership from such at least one investor;
f) assigning at least one unique identifier to such at least one ownership contribution;
g) storing together such at least one ownership contribution and such at least one assigned unique identifier; and
h) confirming such storing together such at least one ownership contribution and such at least one assigned unique identifier to such at least one investor.
